(19) United States
(12) Patent Application Publication
(10) Pub. No.: US 2011/0145270 A1
(43) Pub. Date: Jun. 16, 2011

(54) SERVICE PERSONAS FOR ADDRESS BOOKS

(75) Inventors: John Christopher, Dollard des Ormeaux (CA); Edoardo Gavita, Laval (CA)

(73) Assignee: TELEFONAKTIEBOLAGET LM ERICSSON (PUBL), Stockholm (SE)

(21) Appl. No.: 12/637,545

(22) Filed: Dec. 14, 2009

(51) Int. Cl. G06F 15/16; G06F 17/30

(52) U.S. Cl. 707/769; 707/802; 709/203; 707/E17.044; 707/E17.014

(57) ABSTRACT

Systems and methods according to these exemplary embodiments provide for service personas to be added to network address books, in addition to personal contacts. Address book functionality can be leveraged by service providers to distribute their services and/or service updates to users. Users can leverage address book functionality to search for, register for, and screen updates from, a variety of services.

### TECHNICAL FIELD

The present invention relates generally to communications and, in particular, to methods, devices and systems for establishing service personas in address books.

### BACKGROUND

Interest in using mobile and landline/wireline computing devices in day-to-day communications, as well as to obtain and provide services, continues to increase. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc., also allow users to communicate via e-mail, video conferencing, IM, and the like. Although mobile telephones have conventionally served as voice communication devices, they have recently proven to be effective devices for communicating data and graphics, and to provide an efficient user portal into services, such as location based services, which new technologies have enabled. Wireless and landline technologies continue to merge into a more unified communication system, as user demand for seamless communications and services across different platforms increases.

Many communication applications allow for real-time or near real-time communication that fall outside of the traditional voice communication associated with wireline and wireless telephone communications. Chat session, instant messaging, Short Message Service (SMS), and video conferencing are a few such communication vehicles. Many of these types of communications are expected to become increasingly popular, particularly in view of the proliferation of wireless devices and continual technological breakthroughs in this area. However, issues are still to be solved to enhance the growth of services and, more specifically, to enable users to reach desired services and to enable service providers to reach desired subscribers by leveraging existing architectures and interfaces to establish such connections.

Address book technologies, such as the so-called Converged Address Book (CAB), enable users to control and share their own contact information and to safely store the contact information of others while ensuring that all of the contact information is up-to-date. For mobile subscribers, the number of contacts stored in the address book client applications which are running on their phones typically grows, and the information for each contact typically changes, over time. Thus CAB technologies aim to manage this information growth and keep it up-to-date in an automated manner so that users do not have to track down new information associated with their contacts and then manually update the information in their phone. Instead, this updating process can be performed by an address book server which, for example, matches existing contacts in a user's phone with contacts in internal and external directories associated with the address book server to ensure that complete and accurate contact information is available to the user without requiring the user to manage the contact update processes.

The CAB technologies include, among other things, powerful search and update functionality which is used to achieve these objectives. However, existing CAB technologies have not been used to form connections between service providers and potential service subscribers, e.g., terminal users. Accordingly, systems and methods for informing users about existing and desired services which leverage existing CAB functionality would be desirable.

### SUMMARY

Exemplary embodiments relate to systems and methods for improving communications between users in a network (or networks). According to exemplary embodiments, users are able to identify services and service providers of interest, and service providers are better able to inform potential service subscribers or users of the existence of their particular service, by leveraging address book functionality. Moreover, the address book system provides a control mechanism whereby users can control which services and service providers can contact them, i.e., thereby avoiding unsolicited calls and spam. However, it will be appreciated by those skilled in the art that such advantages are not to be construed as limitations of the present invention except to the extent that they are explicitly recited in one or more of the appended claims.

According to an exemplary embodiment, a method for managing services as part of an address book includes the steps of obtaining, at a Converged Address Book (CAB) node, information to update personal contacts in an address book user's personal contact list, receiving, at the CAB node, service updates from service providers, and selectively transmitting, by the CAB node, the service updates to the address book user.

According to another exemplary embodiment, a Converged Address Book (CAB) network node includes at least one processor configured to obtain information to update personal contacts in an address book user's personal contact list, to receive service updates from service providers and to selectively transmitting the service updates to the address book user.

According to still another exemplary embodiment, a method for managing services as part of an address book in a user equipment (UE) includes the steps of receiving, at the UE, updates associated with contacts for an address book associated with the UE, the updates including at least one service contact in the address book, and displaying, on the UE, a notification associated with an update provided by the at least one service contact.

According to still another exemplary embodiment, a user equipment (UE) includes an interface configured to receive updates associated with contacts for an address book associated with the UE, the updates including at least one service contact in the address book, and a processor connected to a display configured to display, on the UE, a notification associated with an update provided by the at least one service contact.

According to another exemplary embodiment, a method for distributing a service update from a service provider to a plurality of service subscribers includes the steps of providing, on a server associated with the service provider, the service update, receiving, from a Converged Address Book (CAB) node, a request for service updates, transmitting, in response to the request, the service update to the CAB node, evaluating, at the CAB node, the service update relative to criteria submitted by the plurality of service subscribers, selectively transmitting, based on the evaluating step, the service update to the plurality of subscribers, and displaying, on user equipments associated with the plurality of subscribers, information associated with the service updates.

### BRIEF DESCRIPTION OF THE DRAWINGS

The accompanying drawings illustrate exemplary embodiments, wherein:

FIG. 1 depicts a portion of a communication system including an address book according to exemplary embodiments;

FIG. 2 shows communications with an address book server including service updates according to exemplary embodiments;

FIG. 3 is a signaling diagram associated with searching for a service according to exemplary embodiments;

FIG. 4 is a signaling diagram associated with registering for a service according to exemplary embodiments;

FIG. 5 is a signaling diagram associated with updating services and receiving notifications of the services according to exemplary embodiments;

FIG. 6 is a signaling diagram associated with providing service updates according to exemplary embodiments;

FIG. 7 represents an address book node or a user equipment according to exemplary embodiments.

FIG. 8 is an exemplary user interface according to exemplary embodiments; and

FIG. 9 is a flowchart illustrating a method for managing services as part of an address book according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

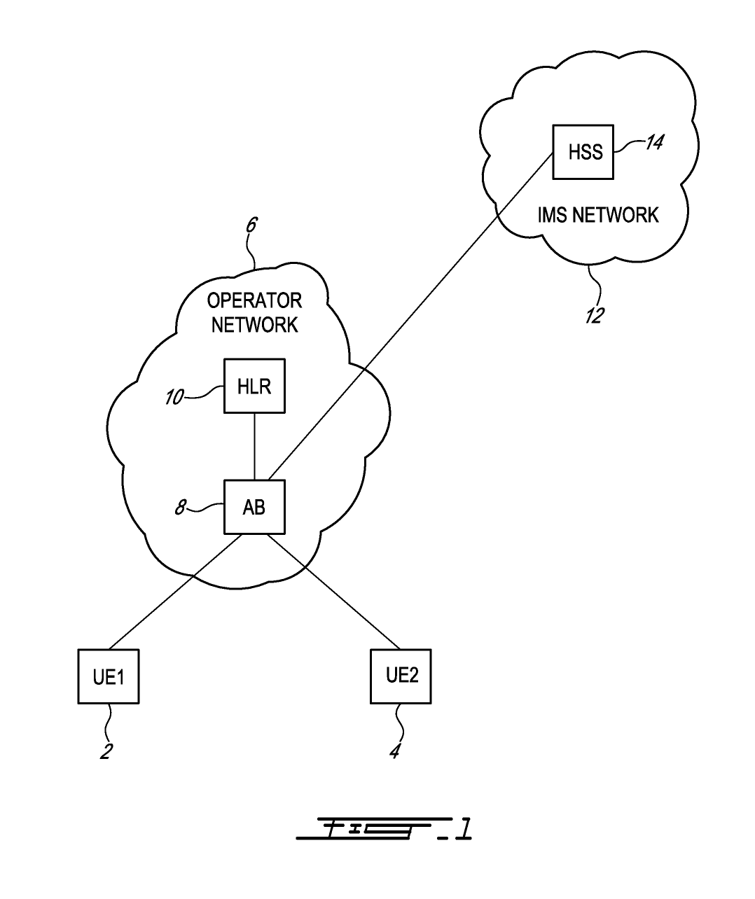

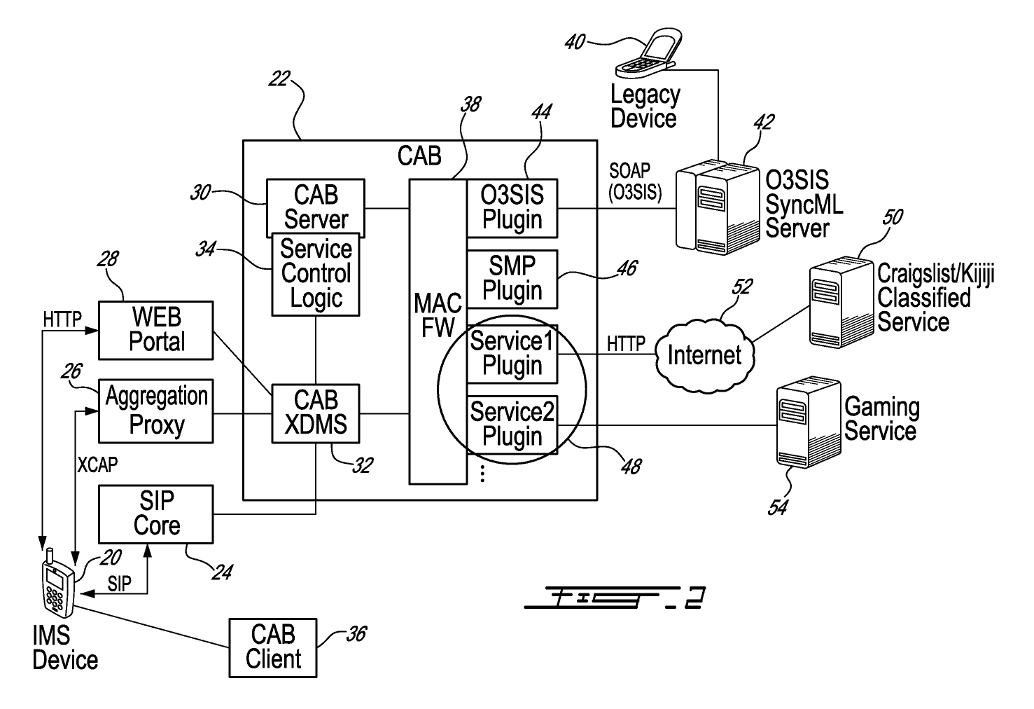

According to exemplary embodiments, address book functionality is leveraged, both in the context of address book servers and address book clients residing on user equipment, to connect users with services in an automated and easily updateable way. Prior to describing such exemplary embodiments, an exemplary (and simplified) communications system in which an address book can reside and provide such service contact information will now be described with respect to FIG. 1.

Therein, user equipments UE1 2 and UE2 4 are in communications with an address book (AB) 8 located in operator network 6, e.g., the AB 8 includes a software entity operating on an application server node in the network 6. As will be described in more detail below, the AB 8 illustrated in FIG. 1 also conceptually represents the address book that is shown (e.g., provided by a Converged Address Book (CAB)) to the user which contains personas associated with people and/or services within the data of each Contact Entry of the Address Book. Operator network 6 also includes a home location register (HLR) 10, which is a database that includes subscriber information for a mobile network. HLR 10 and the AB 8 have an interface over which they can communicate and the AB 8 also has an interface over which it can communicate with a home subscriber system (HSS) 14 located within an Internet Multimedia Subsystem (IMS) network 12. HSS 14 is a database which handles subscriber information for an IMS network 12. According to exemplary embodiments, both the HLR 10 and the HSS 14 can store user information which can be retrieved and stored by the AB 8. Additionally, more nodes, fewer nodes or different network configurations can be used, e.g., the AB 8 could be located in a network which does not include the HLR 10. Also it will be appreciated by those skilled in the art that, typically, the UEs 2 and 4 will be connected to the network 6 and the AB 8 through access points, such as base stations or eNodeBs in a wireless network, and other intervening nodes which are not shown in FIG. 1 to simplify the description.

According to one exemplary embodiment, the AB 8 can be a Converged Address book (CAB) application. The CAB application can provide updated contact information associated to users by keeping the CAB up to date with the latest information published by the contacts themselves. According to exemplary embodiments, this includes notifications being sent by the CAB application regarding both personal contact information and service contact information. As a purely illustrative example, a user could use his or her address book to request a service notification from the CAB when a “Marinello 10 Speed bike is for sale”. Service notifications according to these exemplary embodiments can be issued by the CAB in the form of short message service (SMS), multimedia message service (MMS) or IP multimedia subsystem (IMS) messages.

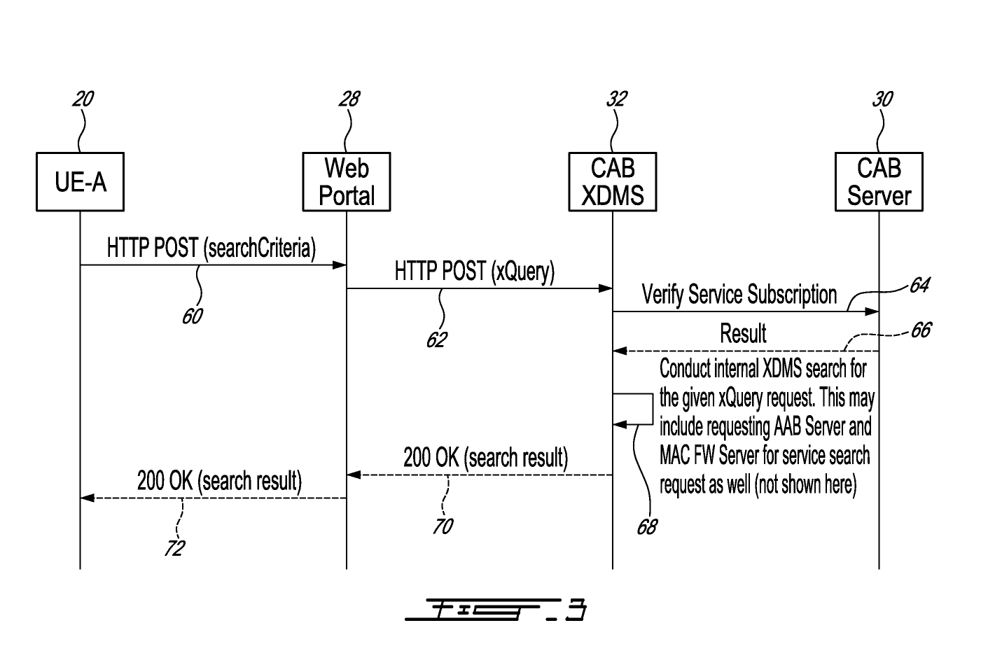

FIG. 2 illustrates some of the extensions which can be provided to existing CAB architectures to support service personas and notifications according to these exemplary embodiments. Therein, an IMS UE 20 is connected to a CAB node 22 via one or more of a plurality of different transport protocols and corresponding system nodes including SIP core 24 (SIP signaling), an aggregation proxy node 26 (XCAP signaling) and a Web portal 28 (HTTP signaling). The IMS UE 20 can then receive contact updates, and provide requests, to the CAB node 22 via any one of these signaling interfaces. Those skilled in the art will appreciate that other signaling interfaces than those illustrated in FIG. 2 could also be used to connect the IMS UE 20 to the CAB node 22.

It will further be appreciated that the present invention is generic to the type of address book application or implementation which is used in a given network. However, as mentioned above, one specific type of address book implementation which is contemplated according to an exemplary embodiment is a Converged Address Book (CAB) as used in Open Mobile Alliance (OMA) specified systems and in accordance with the OMA standard, except to the extent modified herein. Thus FIG. 2 also depicts the CAB node 22 as including a CAB server 30 connected to a CAB eXtensible markup language Data Management Server (XDMS) 32 which can, for example, communicate with the end users via the different signaling protocols and nodes 24, 26 and 28, as well as store service and personal contact card information therein. The CAB server 30 can also contain service contact logic 34 in the form of hardware and/or software which supports the service persona interactions and notifications to be described according to exemplary embodiments below.

The CAB Server 30 is in communications with a CAB Client 36 via the CAB XDMS 32. The CAB Client 36 represents an application running on the IMS UE 20, e.g., a mobile phone with software acting as a CAB Client. According to exemplary embodiments, the CAB Client 36, operating in conjunction with the CAB node 22, can enable the address book service provider to provide a set of Contact Views, each with their associated default set of fields, for use and personalization by each CAB user, potentially subject to any address book service provider policies. More specifically, the user's own contact information being published is sometimes referred to as a Personal Card (PC) or a Personal Contact Card (PCC) in these exemplary embodiments and can be structured with different Contact Views that relate to the user's different interests and relationships, e.g., home, work, gaming, social networks, etc. According to exemplary embodiments, services or service personas can be included as a separate Contact View as part of the user's Personal Card. Thus, according to exemplary embodiments, a Personal Card can contain both personal contact information (i.e., Joe Smith with phone number, etc.) and service and service persona information (i.e., a classified service and BikeForSale persona).

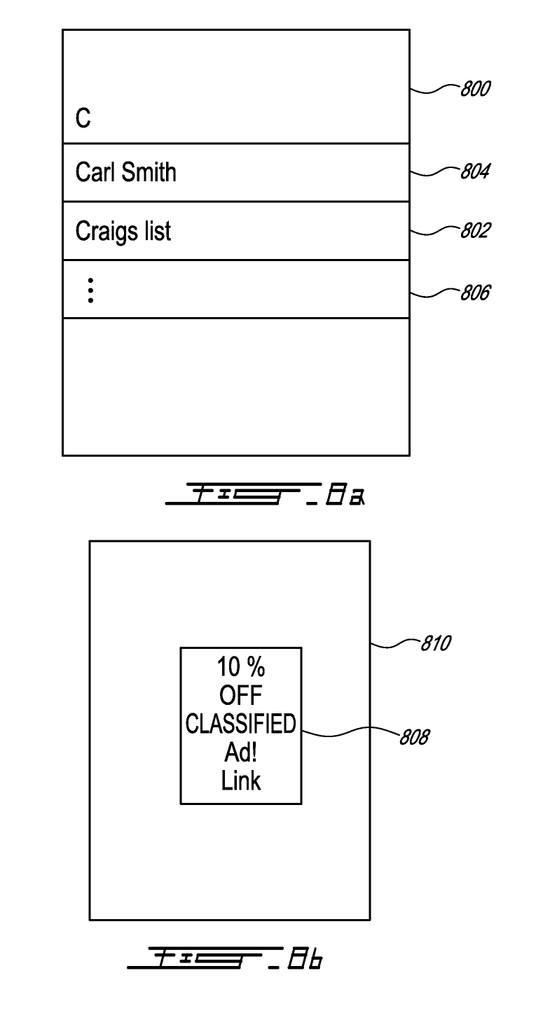

The different Contact Views stored on the Personal Contact Card can be made available to other users based on subscription requests that are authorized by the user owning the PCC. Every user can choose the users, or lists of users, that she or he authorizes to obtain the different Contact Views within their Personal Card. A more detailed example of a user interface associated with a CAB client 36 and showing various Contact Views including service related Contact Views according to an exemplary embodiment is discussed below with respect to FIG. 8.

The information used to generate the Contact Views in the CAB Client 36 can be acquired by the CAB node 22 via MAC Framework (FW) 38 and a plurality of plugins which interface with different data sources. For example, legacy devices (exemplified by legacy UE 40) associated with other users can provide their contact information to CAB node 22 via a SyncML server 42, e.g., via SOAP/O3SIS messaging and a corresponding plug-in 44 to the MAC FW 38. This communication pathway and logic enable, for example, the CAB Client 36 to be updated with individual contact information associated with personal contacts that the user of IMS UE 20 has stored in his or her contact list. Similarly, the SMP plugin 46 can be used by the CAB node 22 to acquire information associated with SMP sources. These plug-ins 44 and 46 can be used, for example, for the CAB node 22 to update personal contact information for personal contacts, e.g., name, telephone number, email address, etc., for an address book user's personal contacts.

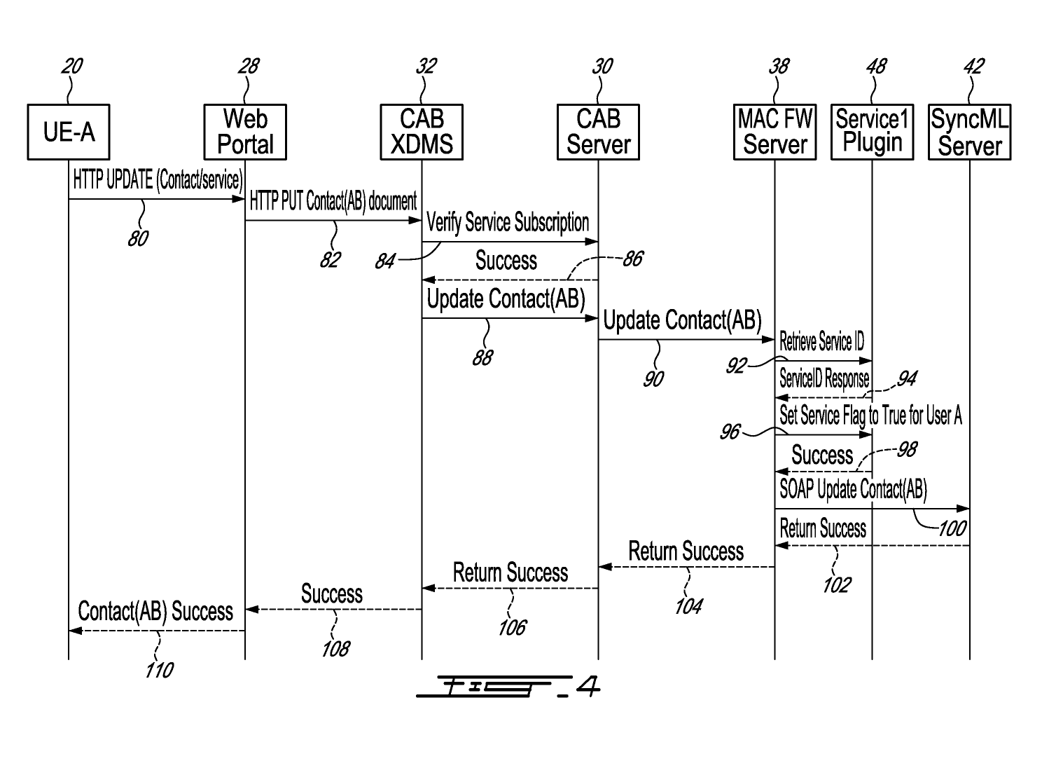

However, exemplary embodiments of the present invention also provide for service plugins 48 to assist in the gathering of information by CAB node 22 which is associated with services that can be used to provide service contacts as Contact Views in the CAB client 36. In the illustrative example of FIG. 2, two such plugins 48 are shown, i.e., one which interfaces between CAB node 22 and a Craigslist/Kijiji classified ad service 50 via the internet 52, and another which interfaces between the CAB node 22 and a gaming service 54. The signaling by way of which such service personas are created and utilized according to exemplary embodiments will now be described with respect to FIGS. 3-6.

FIG. 3 illustrates a signaling flow associated with searching for a new service using an address book server and client according to an exemplary embodiment. Therein, via signal 60, CAB Client 36 associated with the IMS UE 20 sends an HTTP POST signal with search criteria for the user's desired service to the CAB Web Portal. For example, such criteria could include the identity of the service itself (e.g., Craigslist), the service persona (e.g., BikesforSale), keywords (e.g., bike, sale), or other criteria as desired. In response to the HTTP POST signal 60, an XDM client (not shown) located in the CAB WEB Portal 28 will, according to this exemplary embodiment, initiate an XQuery 62 (i.e., a Limited xQuery over HTTP as specified by OMA). The HTTP Post (xQuery) signal 62 includes a Request-URI that identifies the Personal Card (PC) XML document in the target, i.e., the contact being searched (which can, for example, be a person, service or service persona) via the PC XML document. The Search document will contain, e.g., in the <search> attribute the “max-results” value and the list of fields to be returned to the client. An example of such a Search document can be, for the bike sale service search described herein:

<?xml version=“1.0” encoding=“ISO-8859-1”?>
<CAB NewPersonaService>
<Service= Kijiji Classified ADs>

<Service Persona= BikesForSale>
<Push_Pull= Pull>
<Frequency= 60 minutes>

<Search Criteria= Look for bikes for sale under $400>

</CAB NewPersonaService>

If the search criteria sent in signal 62 are not allowed by the CAB node 22, (e.g., it requests data other than PC data or the max-results value set by XQuery 62 is higher than the operator configured value), then the CAB XDMS server 32 can return an error code “400 Bad Request” to the CAB Web Portal 28, and the CAB Web Portal 28 forwards the error message back to the CAB Application Client 36 in UE 20. Otherwise, if the search criteria are valid, the CAB XDMS server 32 sends a request 64 to the CAB server 30 to verify the user's service subscription and the CAB server 30 sends a successful response 66 if the user's service subscription includes the search service and if the user is not blocked.

The user's PC XDMS 32 then performs a search of all of the PC XML documents, filters the results based on authorization rules of each found PC and applies the max-results parameter. For example, if the user had requested a search for a Marinello 10 Speed bike, the CAB XDMS could search all of the PC XML documents which are available to it to determine whether any of the services are offering such a bike for sale, e.g., including the PC XML documents associated with the Craigslist/Kijiji classified ad service 50 described above with respect to FIG. 2. Alternatively, the search could be performed first on the PC XML documents associated with a user's personal contacts and then, if no match is found, the CAB XDMS 32 can issue a search request to the MAC FW 38 to determine whether a match can be found relative to service contacts and/or service personas.

If the request 60 did not specify the PC fields to be returned, the returned fields are based on the configurable parameter “DefaultFieldsInPcSearchResult”. The results also include links to the found PCs, so that the CAB client 36 can use those links to provide the user with more data associated with a specific PC from the search results (assuming that he/she is authorized to see additional data by the service provider). As mentioned above, the CAB server 30 may also check with the MAC FW server 38 to see if it is registered with a specific service name specified in the xQuery 62.

The CAB XDMS server 32 returns a 200 OK message 70 with the search results to the CAB Web Portal server 28. The CAB Web Portal server 28 then returns a 200 OK message 72 with the search results to the CAB Application Client 36. The user of device 20 is then presented with the search results, e.g., via a display on his or her phone, and the possibility to fetch more information regarding any of the identified search hits. The user can also choose one of the results and add it to her/his address book, for example creating a new Contact View associated with the Craigslist service that can be later re-selected to contact that service quickly. If the user selects this option to make one of the returned services a contact in his or her address book, the CAB node 22 will periodically update the contact information associated with that service.

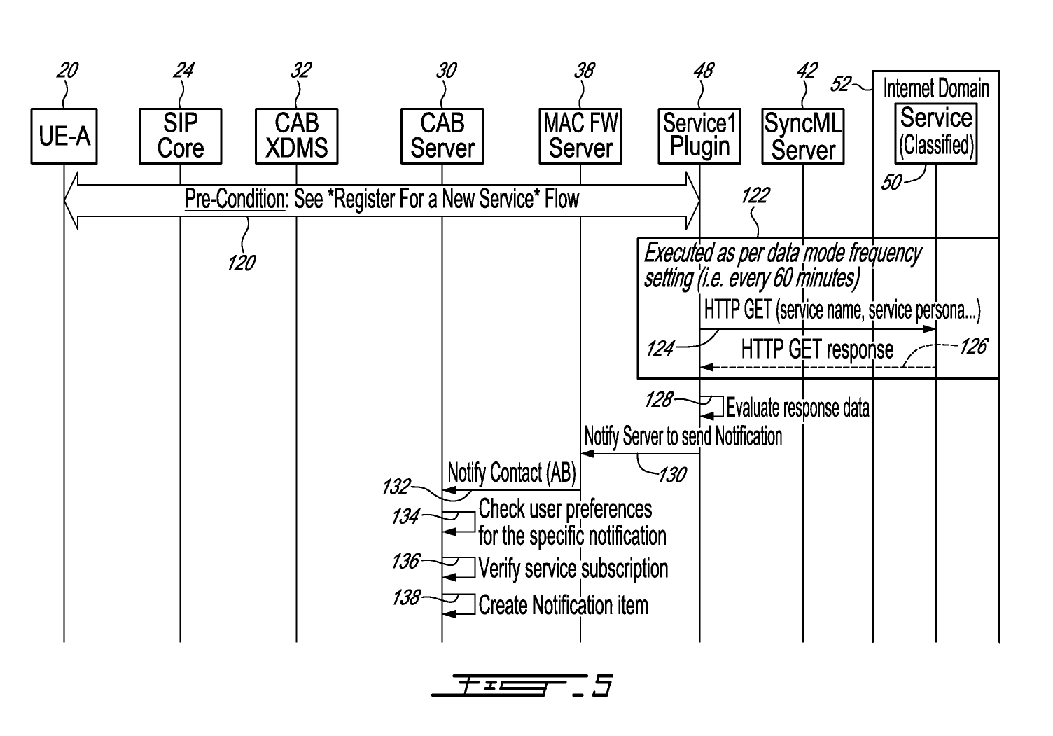

The example of FIG. 3 shows how a user can search for a service in a manner which leverages network address book technology. FIG. 4 is a signaling diagram which illustrates how a user can invoke (i.e., register for) a new service using network address book technology according to an exemplary embodiment. Therein, the CAB Client 36 (operating in UE 20) sends an HTTP request 80 to update its contact list (i.e., to add a new contact/service or update an existing contact/service) to the CAB Web Portal 28. The CAB Web Portal 28 sends an XCAP PUT signal 82 including a Contact(AB) document to the CAB XDMS Server 32. As mentioned above, the contact can be the name of a service for which the user wants to register. The CAB XDMS Server 32 verifies whether the user's subscribed service level authorizes him or her to use the address book to register for services by calling a VerifySubscription( ) function at the CAB server 30 via signal 84.

If the result of the verification is negative, the CAB XDMS 32 generates an XCAP result with “403 Forbidden” error code and sends it back to CAB Web Portal 28 and the process terminates. Assuming, however, that the verification process is successful as shown in FIG. 4, the CAB XDMS Server 32 receives a success verification signal 86 and then sends an Update Contact(AB) signal 88 to the CAB Server 30 to retrieve the address book. The CAB Server 30, in turn, sends an Update Contact(AB) signal 90 to the MAC FW Server 38 to retrieve the address book. The MAC FW Server 38 will issue a service search request 92 to the Service Plugins 48 to determine whether the service being registered by the user is recognized. For example, the MAC FW Server 38 can receive a request to register for a given service and it will query its internal table (not shown) of installed plugins to see if the service in question exists. If the service does exist, then the MAC FW Server 38 will issue request 92 to obtain the service credentials. If no match occurs, then the request 92 is not transmitted.

The Service1 Plugin 48 finds a match for the service which has been requested and returns the Service name and ID in the response 94 to MAC FW Server 38. Upon receiving a successful response from Service1 Plugin 48, MAC FW Server 38 issues a request to set the service flag to TRUE. This tells Service1 Plugin 48 via signal 96 to activate the service for the user of IMS UE 20, who requested to register for the service. The Service1 Plugin 48 will then check for service updates for this particular user and provide notifications through the CAB node 22 to the UE 20 associated with the now registered service. MAC FW Server 38 then receives a success or acknowledgement message 98 from the Service1 Plugin 48. The CAB MAC FW Server 38 sends a SOAP Update Contact(AB) signal 100 to the SyncML Server 42 to update the Contact(AB) to reflect that this service is now a contact of the user of UE 20. The CAB MAC FW Server 38 receives a success or acknowledgement signal 102 from the SyncML Server 42. This success or acknowledgement signal is promulgated back through the network via signals 104-110 to inform the user of the IMS UE 20 that the requested service has been registered with the network and will be provided to the user via his or her terminal.

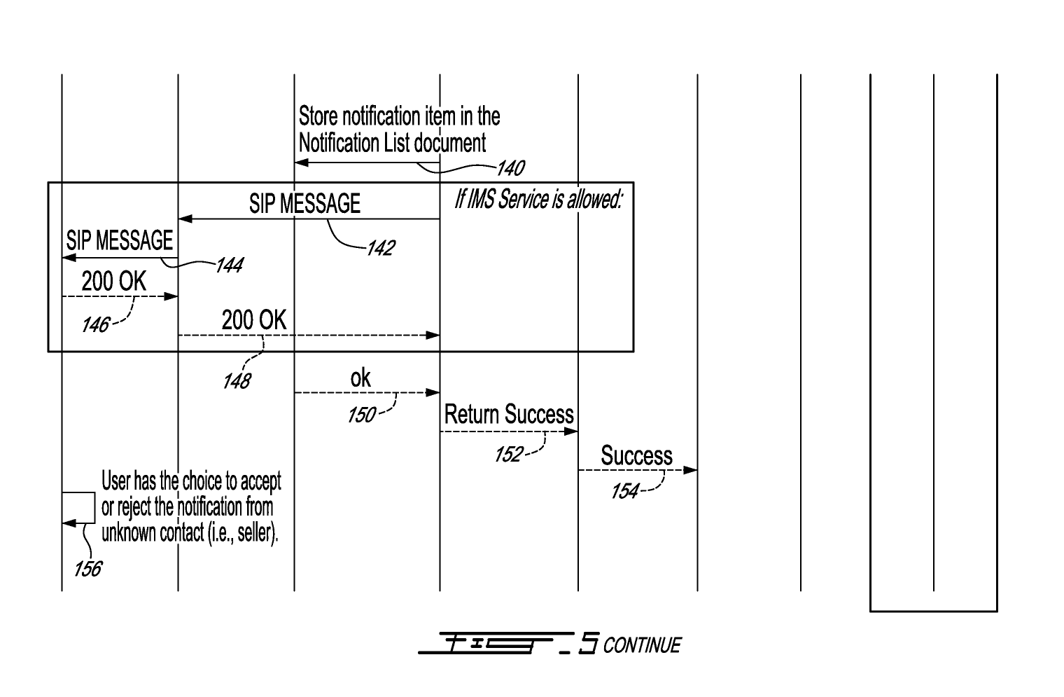

Once a service has been identified (e.g., as described in the exemplary embodiment of FIG. 3) and registered for (e.g., as described in the exemplary embodiment of FIG. 4), the user shall receive updates and notifications from that service at his or her terminal. Note that at this point in the process the User A may not yet have established any contacts in his or her address book regarding a specific service provider which can fulfill the service request of interest, but has instead invoked a service provided by the CAB node to identify a service provider who can fulfill the service request and then let the User A determine whether to establish an address book contact with that particular service provider. An exemplary mechanism for providing such updates and notifications is illustrated in FIG. 5, again leveraging address book functionality.

Therein, as indicated by arrow 120, Service1 Plugin 48 is already registered (on behalf of User A of UE 20) for, e.g., a classified advertisement service. The Service1 Plugin 48 will periodically scan that classified service for any updates for a given service persona which the User A has added to his or her address book, e.g., a service persona which expresses “Want to Buy a Marinello10 Speed bike”. For example, as shown in box 122, the Service1 Plugin 48 can, e.g., every 60 minutes, issue an HTTP request 124 to the external service application server 52. Those skilled in the art will appreciate that a 60 minute periodicity is purely exemplary and that any desired interval for pinging the service could be implemented.

The service responds with an HTTP response signal 126, e.g., indicating whether it has any relevant information associated with the user's request. For example, the information included in signal 126 can include service name, service persona, seller's ID (or email address), price and item description, if a requested item is now available from the service. Service1 Plugin 48 decides, based on pre-defined service criteria and the service information that was just received, to either continue scanning the service for potential matches or to send a notification (i.e., if a service match was found) to the user A. If this evaluation (referenced by arrow 128) determines that a service match did not occur, e.g., the color or price of the Marinello 10 Speed bike identified by the service 52 does not match the user's requested parameters, then the Service1 Plugin 48 will determine that no notification is necessary.

Otherwise if the service information returned by the service matches the criteria sent by the user and/or internally generated criteria, as is the case shown in FIG. 5, the Service1 Plugin 48 informs the MAC FW Server 38 that a service notification is required via signal 130. The MAC FW Server 38 issues a request 132 to CAB Server 30 to send a service notification to User A at UE 20. The CAB Server 30 identifies (step 134) the user preferences for this specific notification, e.g., stored preferences that User A has specified for notifications associated with this particular classified service, verifies (step 136) the user's subscription to determine that User A has subscribed to the address book service notification service and then creates (step 138) a notification item.

The CAB Server 30 then optionally sends a request 140 to the CAB XDMS Server 32 to update the user's Notification List with the notification item associated with this particular update. If the user has IMS service enabled for the specific notification, the CAB Server 30 creates an IMS message 142 which includes the notification item (i.e., a SIP MESSAGE) and sends it to the SIP core 24, e.g., a CSCF node. The CSCF node 1 forwards the SIP MESSAGE 144 to User A device 20. The notification message (initiated from Service1 Plugin 48) showing that a service hit was found can, for example, be displayed on the UE 20 by the CAB Client 36 as for example shown below:

Example Notification Alert (IMS or SMS):

Service: Kijiji Classified ADs
Service Persona: BikesForSale
Item Description: Black Marinello for sale

User A device 20 confirms reception of SIP MESSAGE 144 reception by transmitting a 200 OK message 146. The SIP core (CSCF node) CSCF will redirects the 200 OK message 148 to CAB Server 30. The CAB XDMS 30 provides internal success notification to the MAC FW Server 38 and Service1 Plugin 48 via signals 150, 152 and 154. When presented with the service notification by the CAB client 36, user A has the choice to accept or reject the service notification. If the user chooses to reject the service notification, he or she can, for example, take no action or send back a reject HTTP response (not shown). Alternatively, if the user chooses to accept the notification, then he or she can, for example, click on an “accept” user interface element displayed on his or her terminal device which will return an accept HTTP response (not shown). This operation will mutually connect both parties together through the CAB Server 30.

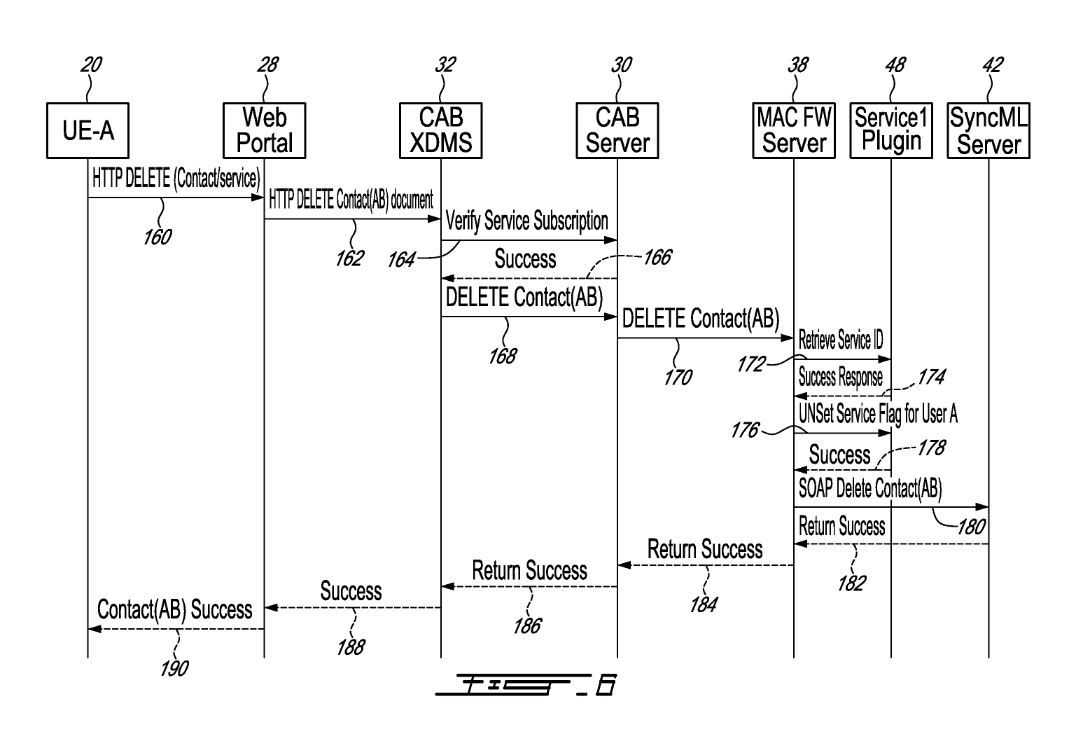

Once a transaction has been completed, e.g., a Marinello 10 Speed bike has been purchased, User A may no longer wish to continue receiving notifications associated with this particular service request. Thus, according to another exemplary embodiment, a mechanism is provided to enable users to de-register from previously registered services. An exemplary signaling flow is provided as FIG. 6. Therein, CAB Client 36 running on UE 20 sends an HTTP request 160 to delete the desired contact (service) to the AB Web Portal 28. The CAB Web Portal 28 sends an XCAP DELETE for Contact(AB) (service) document 162 to CAB XDMS Server 32. The CAB XDMS Server 32 verifies User A′s service level by invoking a VerifySubscription( ) 164 with the CAB Server 30, and receives, in this example, a success verification 166 in return. Alternatively, if the verification result is negative, the CAB XDMS 32 generates an XCAP result with “403 Forbidden” error code and sends it back to CAB Web Portal 28 and the subsequently illustrated steps would not be performed.

The AAB XDMS Server 32 sends a Delete Contact(AB) message 168 to the CAB Server 30 to delete the service contact from the address book. The CAB Server 30 sends the Delete Contact(AB) message 170 to the MAC FW Server 38 to retrieve and delete that contact from the address book. The MAC FW Server 38 issues a service search request 172 to the Service1 Plugin 48 to verify that the service being de-registered is recognized. Service1 Plugin 48 finds a match for the service to be de-registered and returns the service name and ID in the response 174 to MAC FW Server 38. Upon receiving a successful response from Service1 Plugin 48, MAC FW Server 38 will issue a request to “Un-Set” the service flag via signal 176. This tells Service1 Plugin 48 to de-activate the service for the user A, who has opted to de-register for the service. When the MAC FW Server receives a success message 178 from the Service1 Plugin 48, it sends a SOAP Update Contact(AB) (service) message 180 to the SyncML Server 42 to update the Contact(AB). The MAC FW Server 38 receives a success message 182 from the SyncML Server 42 and forwards the successful acknowledgement back through the illustrated chain of nodes to the UE 20 as shown by signals 184-190. When the CAB Client 36 receives this indication it can, optionally, provide an indication to the user on the UE 20 that the service is no longer active. Alternatively, if a SyncML error occurs, the MAC FW Server 38 will receive a SOAP error and the error will be sent back through the various nodes to the CAB Client 36 which can, for example, display an error message such as “Unexpected Error Occurred. Please contact the Operator”.

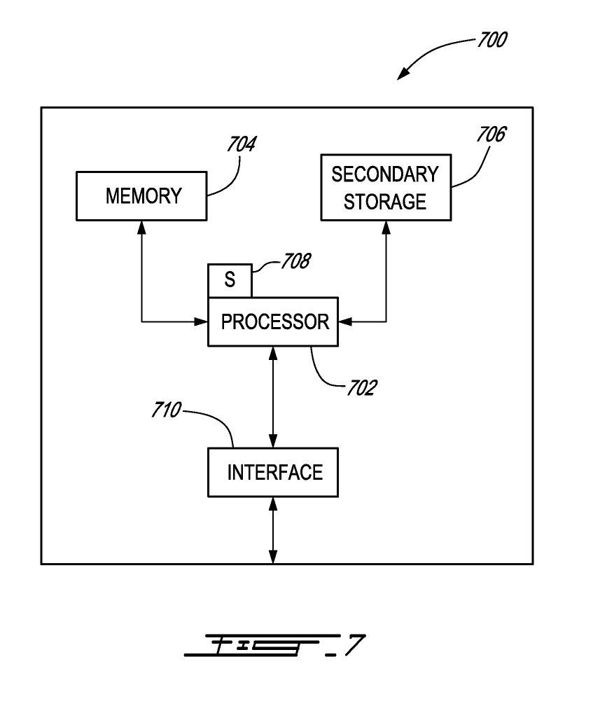

As will be appreciated by the foregoing exemplary embodiments, accessing services leveraging address book technology involves, according to some exemplary embodiments, adding service contact logic 34 and service plug-ins 48 to CAB nodes 22. Generally, a CAB node 22 (which may also be shared by other communication modules to implement other communication functionality in addition to address book functionality) can include the elements illustrated in FIG. 7. Therein, the node 700 includes one or more processor(s) 702 (or processor cores) connected to a memory device 704 and, optionally, a secondary storage device 706. When node 700 is used to implement a CAB node 22, the processor 702 can run software 708 which together provides, among other things, the service contact logic 34 described above that enables the CAB node 22 to operate as described above with respect to, for example, the signaling diagrams of FIGS. 3-6. The node 700 also includes a communications interface 710 which enables the processor 702 to communicate with the other elements within the node, and externally as well.

Node 700 can also generically represent a UE 20, in which case the software 708 running on processor 702 can include software associated with the CAB client 36 described above. Among other things, CAB client 36 can generate various user interfaces to interact with the user A to, for example, interact with the user regarding the various aspects of service acquisition and management described above, e.g., to output notifications regarding registered services and receive inputs from the user regarding service providers to be added as contacts (Contact Views) in his or her address book. For example, suppose that User A described above uses the above described techniques to add Craigslist as a contact in his or her address book. Then, when accessing his or her contacts in a user interface 800 displayed on his or her UE 20, the user could see, for example, an entry 802 for Craigslist entered alphabetically among other personal contacts 804, 806 as shown in FIG. 8(a). If the UE 20 has a touch sensitive screen, the user could then tap the area on which the Craigslist service entry 802 is displayed and another screen can be displayed with more detailed information regarding how to contact Craigslist and/or service updates which are available from that service for this particular user.

Moreover, such functionality provides the opportunity for new service distribution mechanisms according to exemplary embodiments. Suppose, for example, that the operator of the Craiglist service wanted to offer a time-limited discount for users to place new classified ads (or to purchase an item which was listed on Craigslist advertising service). The operator could then, for example, add a discount coupon or link on the Craiglist website (associated with server 50). When the Service Plug-in 48 next queried that server for updates, the discount coupon (or information associated therewith) can be returned to the CAB node 22 and added to the notification list for all users who have added Craigslist as a service contact. An indicator can be provided to the UI of the UE 20 by the CAB Client 36 which alerts the user that a new service update is available, e.g., either by alerting the user immediately on his or her root UI screen, by highlighting the Craigslist entry 802 in the contacts list UI screen displayed on the UE 20 or any other desired mechanism. When the user selects the associated UI interface object indicating a desire to review the service update, the CAB Client 36 can, for example, then display, e.g., a coupon 808 on the display 810 of the UE 20, as illustrated in FIG. 8(b). In this way, a service provider can send automatic updates to many subscribers at the same time simply by updating their website.

It will be apparent from reading the previous exemplary embodiments that such embodiments can be anticipated to provide a number of advantages and benefits relative to existing technologies including, for example, increasing an operator's overall network traffic and corresponding return on investment. Additionally such embodiments enable re-use of existing protocols, such as SyncML, for new applications to tap into existing large subscriber bases without necessarily requiring upgrades of subscribers' mobile devices.

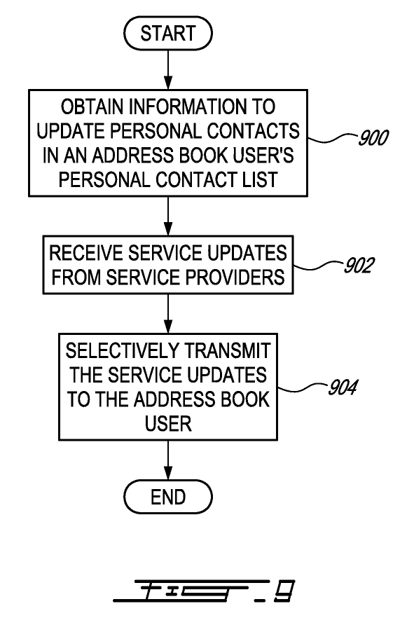

Thus, according to one exemplary embodiment, a method for managing services as part of an address book can be performed as shown in the flowchart of FIG. 9. Therein, at step 900, information is obtained, at a Converged Address Book (CAB) node, to update personal contacts in an address book user's personal contact list. The CAB node also receives service updates from service providers as shown in at step 902. The CAB node selectively transmits, e.g., based upon an evaluation regarding whether the service updates meet one or more criteria regarding the corresponding service request, to the address book user.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for managing services as part of an address book, the method comprising:
obtaining, at a Converged Address Book (CAB) node, information to update personal contacts in an address book user's personal contact list;
receiving, at said CAB node, service updates from service providers; and
selectively transmitting, by said CAB node, said service updates to said address book user.

2. The method of claim 1, further comprising:
initiating a search, at said CAB node, for a service requested by said address book user.

3. The method of claim 2, further comprising:
registering, by said CAB node, said address book user for service updates associated with said service.

4. The method of claim 3, wherein said step of receiving further comprises:
obtaining, by said CAB node, said service updates from at least one application server which provides said service.

5. The method of claim 4, wherein said step of selectively transmitting further comprises:
evaluating, by said CAB node, each of said service updates to determine whether they meet at least one criterion associated with said service as requested by said address book user; and
transmitting said service updates if they meet said at least one criterion.

6. The method of claim 1, further comprising:
receiving, at said CAB node, an indication from said address book user to add a service provider as a contact in said address book user's personal contact list; and
periodically updating contact information associated with said service provider in said address book user's personal contact list in addition to contact information associated with said personal contacts.

7. A Converged Address Book (CAB) network node comprising:
at least one processor configured to obtain information to update personal contacts in an address book user's personal contact list, to receive service updates from service providers and to selectively transmitting said service updates to said address book user.

8. The CAB network node of claim 7, further comprising:
a CAB MAC framework (FW) server configured to manage a plurality of plug-ins, including at least one personal contact plug-in for obtaining said information to update said personal contacts in said address book user's personal contact list, and at least one service plug-in which receives said service updates;
a CAB XDMS server configured to communicate with user equipments, including selectively transmitting said service updates to said address book user; and
a CAB server configured to coordinate operation of said CAB MAC FW and said CAB XDMS server.

9. The CAB network node of claim 7, wherein said at least one processor is further configured to initiate a search for a service requested by said address book user.

10. The CAB network node of claim 9, wherein said at least one processor is further configured to register said address book user for service updates associated with said service.

11. The CAB network node of claim 10, wherein said at least one processor is further configured to obtain said service updates from at least one application server which provides said service.

12. The CAB network node of claim 7, wherein said at least one processor is further configured to evaluating each of said service updates to determine whether they meet at least one criterion associated with said service as requested by said address book user, and to transmit said service updates if they meet said at least one criterion.

13. The CAB network node of claim 7, further comprising:
a communication interface configured to receive an indication from said address book user to add a service provider as a contact in said address book user's personal contact list, and
wherein said processor is further configured to periodically update contact information associated with said service provider in said address book user's personal contact list in addition to contact information associated with said personal contacts.

14. A method for managing services as part of an address book in a user equipment (UE), the method comprising:
receiving, at said UE, updates associated with contacts for an address book associated with said UE, said updates including at least one service contact in said address book; and
displaying, on said UE, a notification associated with an update provided by said at least one service contact.

15. The method of claim 14, wherein said notification includes information responsive to a service search request previously transmitted by said UE toward a Converged Address Book (CAB) node.

16. The method of claim 15, further comprising:
receiving, at said UE, a signal from said CAB node which identifies a service in response to said service search request; and
transmitting, by said UE, a signal toward said CAB node requesting registration for service updates associated with said service which includes at least one criterion to be used to evaluate said service updates.

17. A user equipment (UE), comprising:
an interface configured to receive updates associated with contacts for an address book associated with said UE, said updates including at least one service contact in said address book; and
a processor connected to a display configured to display, on said UE, a notification associated with an update provided by said at least one service contact.

18. The UE of claim 17, wherein said notification includes information responsive to a service search request previously transmitted by said UE toward a Converged Address Book (CAB) node.

19. The UE of claim 18, wherein said interface is further configured to receive, at said UE, a signal from said CAB node which identifies a service in response to said service search request, wherein said processor is further configured to transmit a signal toward said CAB node requesting registration for service updates associated with said service which includes at least one criterion to be used to evaluate said service updates.

20. A method for distributing a service update from a service provider to a plurality of service subscribers, the method comprising:
providing, on a server associated with said service provider, said service update;
receiving, from a Converged Address Book (CAB) node, a request for service updates;
transmitting, in response to said request, said service update to said CAB node;
evaluating, at said CAB node, said service update relative to criteria submitted by said plurality of service subscribers;
selectively transmitting, based on said evaluating step, said service update to said plurality of subscribers; and
displaying, on user equipments associated with said plurality of subscribers, information associated with said service updates.
